(19) United States
(12) Patent Application Publication
(10) Pub. No.: US 2008/0116234 A1
(43) Pub. Date: May 22, 2008

(54) RIBBON CURLING DEVICE

(75) Inventors: GERALD E. MUELLER, Eagan, MN (US); Joy A. Packard, Somerset, WI (US); Scott D. Pearson, Woodbury, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 11/941,148

(22) Filed: Nov. 16, 2007

Related U.S. Application Data
(60) Provisional application No. 60/866,230, filed on Nov. 17, 2006.

(51) Int. Cl. B26B 27/00; D04D 9/00

(52) U.S. Cl. 223/46; 493/459

(57) ABSTRACT

A ribbon curling device having opposing first and second surfaces bound by two side edges and front and rear ends. The device has an elongated handle and a ribbon curling region extending from the handle and comprising a curling edge, the region having first and second ends. The first end of the ribbon curling region lies proximate to the front end of the handle and wherein the second end of the ribbon curling region is tapered.

### CROSS-REFERENCE TO RELATED APPLICATION

This application claims the benefit of U.S. Provisional Patent Application No. 60/866,230, filed on Nov. 17, 2006.

### FIELD OF INVENTION

The present invention relates to a ribbon curling device that optionally includes means for cutting media, such as a blade. In particular, the invention relates to a hand-held, portable, light weight, ergonomic device that curls ribbon easily and in some embodiments, the device can cut media, such as, e.g., paper, plastic, metal films, fabrics, and ribbon.

### BACKGROUND

There are a variety of devices available today for curling ribbon. A ribbon is typically a non-woven material, such as, e.g., polypropylene, that curls when a tension or a shear force is applied to its surface. Consumers have used a blade of a scissor to curl ribbon. Typically, using a finger (usually the thumb) the consumer pushes the ribbon against the scissor blade and pulls the ribbon through thereby applying tension to the ribbon and curling it.

There are devices that combine ribbon curling and ribbon shredding, such as those disclosed in U.S. Pat. Nos. 5,232,132 (Broussard et al.) and 3,883,953 (Saullo et al.) where the curling and shredding processes are combined in one step and U.S. Pat. No. 5,054,699 (DeJaynes) where the ribbon curling process is separate from the ribbon shredding process. Besides scissors, there are also devices that combine cutting and curling ribbon, such as those disclosed in U.S. Pat. No. 5,205,007 (Goldstein) and Publication WO 95/35190.

While there are ribbon curling devices commercially available, other devices are still needed.

### SUMMARY

In one aspect, the present invention pertains to a ribbon curling device having opposing first and second surfaces bound by two side edges and front and rear ends, the device comprising (i) an elongated handle; and (ii) a ribbon curling region extending from the handle and comprising a curling edge, the region having first and second ends, wherein the first end is disposed proximate to the front end of the handle, and wherein the second end of the ribbon curling edge is tapered.

The invention combines the functionality of ribbon cutting and optionally media cutting with an attractive and ergonomic design to create a particularly useful and elegant design. One advantage of the present invention is that the design of the ribbon curling region is such that it allows the user to comfortably place a finger across the entire region thereby adding stability to the ribbon curling process.

### BRIEF DESCRIPTION OF THE DRAWINGS

The invention can be better described with reference to the drawings, wherein:

FIG. 1 is a bottom plan view of an exemplary ribbon curling device;

FIG. 2 is a side view of the device of FIG. 1;

FIG. 3 is a bottom perspective view of an exemplary ribbon curling and media cutting device;

FIG. 4 is a side view of the device of FIG. 3;

FIG. 5 is a perspective view of an exemplary ribbon curling device that can be formed separately and attached to a handle to form the device of the present invention; and

FIG. 6 is a schematic view of a method of curling a ribbon using an exemplary curling device.

These figures are idealized, are not drawn to scale, and are intended merely for illustrative purposes.

### DETAILED DESCRIPTION

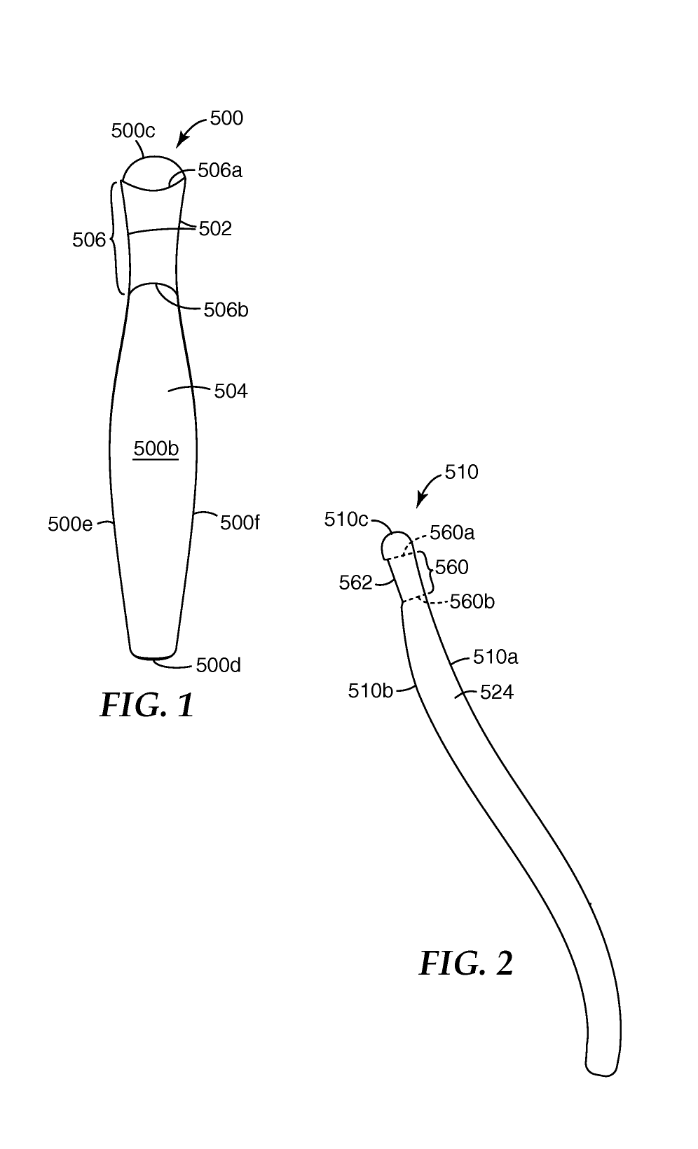

FIG. 1 shows a bottom plan view of an exemplary ribbon curling device 500 that includes a handle 504. The device includes opposing first surface (not shown) and second surface 500b bound by two side edges, 500e and 500f. The device has a front end 500c and a rear end 500d. On at least one of the first and second surfaces of the device, there is a ribbon curling region 506 that has a first end 506a and a tapered second end 506b, i.e., as compared to the first end, the second end has a narrower dimension, as seen from the bottom plan view shown here. The first end of the ribbon curling region is proximate to the front end of the handle. The ribbon curling region has a curling edge 502 formed by a juncture of, in this case, the second surface of the device and one of the side edges. If desired, the ribbon curling region may include a plurality of curling edges. FIG. 2, a side view of the device of FIG. 1, shows that the ribbon curling region necks down, in terms of thickness, from the handle.

In some embodiments, the combination device may have more than one curling edge. In one embodiment, and as shown particularly in FIG. 1, the ribbon curling device includes two curling edges, disposed symmetrically on the device, which is particularly convenient, as it allows for left-handed as well as right-handed use during ribbon curling. Furthermore, multiple curling edges extend the life of the device because when one edge is worn, other edges are available for use. Another method to extend the life of the curling edge involves selecting a material that has improved hardness and wear resistance, so that after multiple uses, the radius of curvature of the curling edge (as described below) has not changed substantially and is within the limits recited. Suitable materials for the curling edge include plastics, metals, and ceramics. Suitable plastics include, without limitation, polycarbonate, polystyrene, ABS, and acetal.

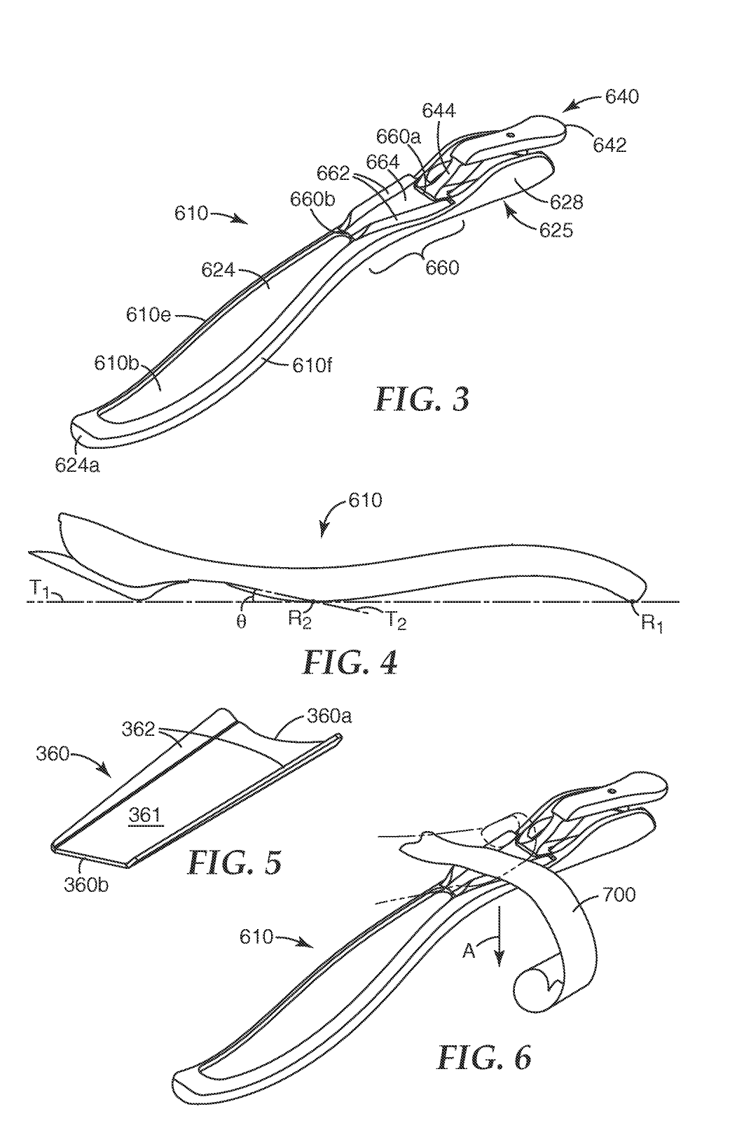

FIG. 3 shows a bottom plan view of a ribbon curling device combined with media cutting capability (sometimes referred to as a “combination device”). A suitable media cutting device is disclosed in U.S. patent application Ser. No. 11/408781 filed on Apr. 21, 2006, which is hereby incorporated by reference in its entirety.

A ribbon curling, media cutting device 610 includes a head 625 and a handle 624 extending therefrom. The handle has a rear end 624a. The head includes a cover (not labeled) having sidewalls 628 extending therefrom, and an optional guide 640 disposed substantially underneath the cover. The guide has an attached end 644 closest to the handle, and a free end 642, which in one embodiment, extends beyond the cover. A cutting device, such as a blade, is disposed in the guide. The combination device includes opposing first surface (not shown) and second surface 610b bound by two side edges, 610e and 610f. The second surface of the device lies on the same side as a guide. On the handle and on at least one of the first and second surfaces of the device, there is a ribbon curling region 660 that has a first end 660a and a tapered second end 660b, i.e., as compared to the first end, the second end has a narrower dimension, as seen from the bottom plan view of the device. The first end of the ribbon curling region is proximate to the head, and more specifically, proximate to the attached end of the guide. The ribbon curling region includes two curling edges 662 that are formed from rails that extend from the second surface of the device. While the rails are shown to be immediately adjacent to the side edge of the device, it can be located in other positions in the ribbon curling region. For example, the rail can be towards the center of the ribbon curling region. In this particular embodiment, the rails have a substantially triangular cross section where the base of the triangle lies on the second surface of the device and a tip of the triangle extends from the triangle's base. The exposed sides of the triangle (i.e., not the base of the triangle) may have curvature. If one were to draw two tangent lines, one for each of the exposed side, each passing through the tip of the triangle and measure the angle between those two tangent lines, the angle is less than about 90°. In one embodiment, the angle is less than about 60°. It should be noted that the tip of the triangle may not be a distinct sharp point but instead may include a plateau. The tip of the rail is the ribbon contact point. If one were to measure the radius of curvature of the tip, it is less than about 0.02 inch (0.51 mm). In one embodiment, the radius of curvature of the tip is less than about 0.015 inch (0.38 mm). The radius of curvature of the rail, however, is greater than 0.001 inch (0.025 mm) because below this limit, the radius may be too sharp thereby abrading and causing damage to the ribbon. At a radius of greater than about the recited upper limited of 0.02 inch, the ribbon contacts too large of a surface area to provide effective curling.

In between the two curling edges lies land 664. The height of the rail, as measured perpendicular to the land, is less than about 0.2 inch (5.1 mm). In one embodiment, the rail height is less than about 0.12 inch (2.9 mm). The rail height, however, should be greater than about 0.01 inch (0.25 mm) because it should provide a feature to the ribbon curling edge. The land in between the rails provides a region for the user to balance, rest, and support the rest of his finger while curling the ribbon thereby minimizing any rocking of the finger as well as providing comfort for the user during use. If the rail height was too large, i.e., greater than the upper limit of about 0.2 inch, the likelihood of finger rocking increases. While the substantially triangular cross-section rail described herein provides utility as the curling edge, other designs could be used. For example, one could use a wedge shape design.

FIG. 4 is a side view of the combination device of FIG. 3 placed on a substantially planar surface (e.g., a table top) such that the optional guide is adjacent to the planar surface. A first plane can be defined to encompass the curling edge and is coplanar with the second surface of the device in the ribbon curling region. The first plane is illustrated schematically in two-dimensions, as line T₁. The handle of the device is curved such that when placed on the planar surface, two resting points support the device. The first resting point, R₁, lays on the second surface and at the rear of the handle. A second resting point, R₂, also lies on the second surface of the handle and near the ribbon curling region. A second plane can be defined to encompass both resting points and is denoted as line T₂. The intersection of the first and second planes creates an angle θ. In one embodiment, the angle is greater than about 5° and less than about 80°. In another embodiment, the angle is about 10°.

The design of the handle with the particular curvature makes the device particularly comfortable for use in the cutting mode or in the ribbon curling mode. In the cutting mode, the user may grasp the handle around her palm, with one side of the device, e.g., side 610e in contact with the thumb and the opposing side, side 610f, in contact with the side of her index finger, and the back of the hand generally facing her. In the ribbon curling mode, the same grasp can be used, however, the back of her hand faces away from her and her fingers may all be within her direct line of sight. This grasp is particularly useful for curling ribbon as the angle θ is in the range where the thumb rests comfortably and securely against the ribbon curling edge. That is, the angle θ is designed such that the largest part of the thumb is resting against the ribbon curling edge and against the side of the index finger closest to the knuckles of the hand. It would be less desirable to have a ribbon curling region where the thumb, when grasping the device in anticipation of curling ribbon, is far away from the side of the index finger, such as, e.g., when the thumb is in the hand gesture of a “thumbs up” position because only a minimal force can be applied to the ribbon.

In the combination device, the head and handle, along with the ribbon curling region can be integrally formed or it can be formed separately and attached to the handle by any suitable means. Illustrative attachment techniques include, without limitation, mechanical means, such as, without limitation, heat welding, ultrasonic welding, screws and corresponding threads, pins and corresponding holes, and adhesives means, such as, without limitation, liquid adhesives such as cyanoacrylates and double coated tape.

FIG. 5 is a perspective view of an exemplary ribbon curling region 360 that can be formed separately and attached to the media cutter to form the combination device. The ribbon curling region has a first and second ends, 360a and 360b respectively, where the second end is tapered, i.e., narrower in dimension as compared to the first end. The ribbon curling region also has two curling edges 362 separated by land 361. The land has opposing top and bottom surfaces where, upon attachment to a media cutter, the bottom surface would be proximate to and perhaps in contact with the first or second surface of the device.

FIG. 6 is a schematic view of an exemplary process of curling a length of ribbon 700 using the device of FIG. 3. The ribbon has been wedged between a consumer's thumb (shown in phantom) and one of the curling edges. To curl the length of ribbon, the consumer pulls the ribbon in the direction indicated by the arrow A, although alternative methods can be used.

If desired, the ribbon curling device and or the combination device can be formed of a first polymeric material and a second polymeric material can be used on at least one of the first and second surfaces of the device. The first and second polymeric material can be of the same material. In an alternative embodiment, the first and second polymeric materials have different properties, such as, without limitation, different hardness or softness (in terms of durometer), different colors, and a combination of these two properties. In one embodiment, the handle, whether on the first surface or the second surface, includes two different polymeric material, the first material substantially forming the overall shape of the handle, and the second material covering over a portion of the first material, the second material being softer and of a different color. In this way, the combination device has aesthetic appeal while providing a soft touch effect providing better even better gripping action for the consumer.

Although specific embodiments of the present invention have been shown and described, it is understood that these embodiments are merely illustrative of the many possible specific arrangements that can be devised in application of the principles of the invention. Numerous and varied other arrangements can be devised in accordance with these principles by those of ordinary skill in the art without departing from the spirit and scope of the invention. Thus, the scope of the present invention should not be limited to the structures described in this application, but only by the structures described by the language of the claims and the equivalents of those structures.

What is claimed is:

1. A ribbon curling device having opposing first and second surfaces bound by two side edges and front and rear ends, the device comprising:
an elongated handle; and
a ribbon curling region extending from the handle and comprising a curling edge, the ribbon curling region having first and second ends, wherein the first end is disposed proximate to the front end of the handle and wherein the second end of the ribbon curling region is tapered.

2. The device of claim 1, wherein the curling edge is formed by a juncture of one of the side edges and one of the first and second surfaces.

3. The device of claim 2, wherein the juncture is about a 90° angle.

4. The device of claim 1, wherein the curling edge comprises a rail that extends from the first or second surface of the device, the rail having a base and a highest point, the base being disposed on the device and the highest point being furthest away from the device.

5. The device of claim 4, wherein the curling edge is disposed immediately adjacent to the side edge of the device and the ribbon curling region further comprises a land next to the curling edge.

6. The device of claim 5, wherein the rail has a minimum height of greater than about 0.25 mm and a maximum height of less than about 5 mm, the height being measured perpendicular to the land and the highest point on the rail.

7. The device of claim 4, wherein the highest point of the rail has a radius of curvature greater than about 0.025 mm and less than about 0.51 mm.

8. The device of claim 4, wherein the rail has a substantially triangular cross-section having a base disposed on at least one of the first or second surface of the device, two exposed sides, and a tip that extends from the base.

9. The device of claim 8, wherein two tangent lines, one for each of the exposed sides and passing through the tip, intersect at an angle less than about 90°.

10. The device of claim 8, wherein two tangent lines, one for each of the exposed sides and passing through the tip, intersect at an angle less than about 60°.

11. The device of claim 1, wherein the curling edge is formed from a wear resistant material selected from the group consisting of plastic, metal, and ceramic.

12. The device of claim 11, wherein the plastic is selected from the group consisting of polycarbonate, polystyrene, acrylonitrile-butadiene-styrene copolymer, and acetal.

13. The device of claim 1, wherein the ribbon curling region is formed integrally with the handle.

14. The device of claim 1, wherein the ribbon curling region is formed separately from the handle and attached to the handle using mechanical and or adhesive attachment means.

15. The device of claim 1, wherein at least one of the head and the handle is formed from a first polymeric material and wherein at least one of the first and second surfaces of the handle include a second polymeric material having a characteristic selected from the group consisting of a lower durometer than the first polymeric material, a different color than the first polymeric material, and a combination thereof.

16. The device of claim 1, wherein the curling edge is disposed on the second surface of the device, and wherein an angle θ is formed between (i) a first plane that encompasses the curling edge and is substantially coplanar with the second surface of the device in the ribbon curling region and (ii) a second plane encompassing first and second resting points on the second surface of the device when it is placed on a substantially planar surface, the angle θ being greater than about 5° and less than 80°.

17. The device of claim 16 wherein the angle θ is about 10°.

18. The device of claim 1, wherein the handle includes curvature such that when the device is placed on a substantially planar surface, the device rests on two resting points located on its second surface, a first resting point at a rear of the handle and a second resting point proximate to the ribbon curling region.

19. The device of claim 1 further comprising a head extending from the front end of the device, the head comprising a cover and a guide disposed substantially underneath the cover, the guide having an attached end and a free end and a blade disposed therein
